(19) United States
(12) Patent Application Publication
(10) Pub. No.: US 2015/0004587 A1
(43) Pub. Date: Jan. 1, 2015

(54) DYNAMIC BLENDED LEARNING SYSTEM

(71) Applicant: Edison Learning Inc., Pittsburgh, PA (US)

(72) Inventors: Raymond Rozycki, McDonald, PA (US); David Zeiler, Pittsburgh, PA (US); Gabriel Enck, Pittsburgh, PA (US)

(21) Appl. No.: 14/317,884

(22) Filed: Jun. 27, 2014

Related U.S. Application Data
(60) Provisional application No. 61/840,747, filed on Jun. 28, 2013.

(51) Int. Cl. G09B 7/08

(52) U.S. Cl. CPC G09B 7/08
USPC 434/322

(57) ABSTRACT

A system and method of e-learning. A series of custom learning objects is displayed, wherein the learning objects form at least part of an e-learning course that has a mix of modes of learning. The proficiency of the student relating to content of the custom learning objects is accessed. A revised mix for the modes of learning is determined based on the assessment of the proficiency of the student and the modes of learning for the custom learning objects. An additional series of custom learning objects is displayed to the student through the course delivery system, where the additional custom learning objects are based on the revised mix for the modes of learning.

### CROSS REFERENCE TO RELATED APPLICATIONS

The present application claims benefit to the filing date of Provisional Application No. 61/840,747, filed on Jun. 28, 2013.

### TECHNICAL FIELD OF THE INVENTION

The present disclosure relates to e-learning systems and methods, and more particularly, to e-learning systems and methods where a students learning path is adjusted based on proficiency assessments.

### BACKGROUND OF THE INVENTION

E-learning is an inclusive term that describes educational technology that electronically or technologically supports learning and teaching. E-learning includes numerous types of media that deliver text, audio, images, animation and video through technology applications and processes such as computers, local intranet/extranet and the Internet. E-learning can occur in or out of the classroom. It can be self-paced, asynchronous learning or may be instructor-led, synchronous learning. E-learning is suited to distance learning and flexible learning, but it can also be used in conjunction with face-to-face teaching, in which case the term blended learning is commonly used.

Computer-based learning or training (CBT) refers to self-paced learning activities delivered on a computer or handheld device such as a tablet or smartphone. CBT often presents content in a linear fashion, much like reading an online book or manual. Assessing learning in a CBT is often by assessments that can be easily scored by a computer such as multiple choice questions, drag-and-drop, radio button, simulation or other interactive interfaces. Assessments are easily scored and recorded via software, providing immediate end-user feedback and completion status. CBTs provide learning stimulus beyond traditional learning methodology from textbook, manual, or classroom-based instruction. For example, CBTs offer user-friendly solutions for satisfying continuing education requirements. Instead of limiting students to attend courses or reading printed manuals, students are able to acquire knowledge and skills through methods that are more conducive to individual learning preferences. For example, CBTs offer visual learning benefits through animation or video, not typically offered by any other means. CBTs can be a good alternative to printed learning materials since rich media, including videos or animations, can easily be embedded to enhance the learning. CBTs pose some learning challenges. Typically, the creation of effective CBTs requires enormous resources. The software for developing CBTs is often more complex than a subject matter expert or teacher is able to use.

Computer-supported collaborative learning (CSCL) uses instructional methods designed to encourage or require students to work together on learning tasks. Collaborative learning is distinguishable from the traditional approach to instruction in which the instructor is the principal source of knowledge and skills. In contrast to the linear delivery of content, often directly from the instructor's material, CSCL uses blogs, wikis, and cloud-based document portals. With technological Web 2.0 advances, sharing information between multiple people in a network has become much easier and use has increased. Using CSCL social tools in the classroom allows for students and teachers to work collaboratively, discuss ideas, and promote information. After initial instruction on using the tools, students may report an increase in knowledge and comfort level for using CSCL tools. The collaborative tools also prepare students with technology skills necessary in today's workforce.

One of the strengths of CBT and CSCL, the ability for self-paced learning by individuals, also creates significant drawbacks in that it limits the ability for students in developing core learning skills, such as inter-personal skills and the ability to interact in completing work in a collaborative environment.

It is with respect to these considerations and others that the present invention has been made.

### SUMMARY OF THE INVENTION

The Blended Learning Suite is a set of teacher and administrator applications tied in with the student facing course delivery system and the eSchoolware LMS. Its goal is to allow teachers, learning coaches and administrators the ability to monitor and manage all students and coursework involved in the Edison Learning software. Each individual has access to just the tools they need, and it is possible for one person to log in as both the teacher and learning coach roles (or other combination of roles) with separate logins or permissions.

The suite provides the ability to flag Interventions for review and action, create custom content, monitor and assign curricular based tasks to students, assign tutoring, and schedule the use of classroom resources.

By bringing issues to the correct people's attention, that person no longer has to wade through the fine details to spot problems. By creating automated options, and identifying available resources, teachers and learning coaches are able to resolve common issues with less effort. And for the more serious cases, they are free to drill down into the details, and then create personal and customized responses.

Content and assessment questions are linked to specific Common Core standards. In addition, all lessons are identified by Learning Mode, allowing the teacher an easy way to monitor the software's Blended Learning paradigm. The product also tags all custom created content with standard and learning mode.

In one aspect, the personalized learning plan is automatically adjusted by a computing system. A series of custom learning objects is displayed, wherein the learning objects form at least part of an e-learning course that has a mix of modes of learning. The proficiency of the student relating to content of the custom learning objects is accessed. A revised mix for the modes of learning is determined based on the assessment of the proficiency of the student and the modes of learning for the custom learning objects. An additional series of custom learning objects is displayed to the student through the course delivery system, where the additional custom learning objects are based on the revised mix for the modes of learning.

### BRIEF DESCRIPTION OF THE DRAWINGS

The figures are for illustration purposes only. However, the invention itself may best be understood by reference to the detailed description which follows when taken in conjunction with the accompanying drawings in which:

FIG. 1 illustrates a flow chart for an exemplary embodiment of the blended learning suite;

FIG. 2 illustrates an exemplary dashboard;

FIG. 3A illustrates a teacher's desktop scheduler view of an exemplary embodiment;

FIG. 3B illustrates a student's desktop scheduler view of an exemplary embodiment;

FIG. 4 illustrates an exemplary class view;

FIG. 5 illustrates an exemplary list view of students;

FIG. 6 illustrates an exemplary custom learning object slide out;

FIG. 7 illustrates an exemplary resource manager tool under a class view;

FIG. 8 illustrates an exemplary curriculum manager tool;

FIG. 9 illustrates a learning object scheduler, consistent with an exemplary embodiment;

FIG. 10 illustrates an exemplary physical resources manager view;

FIG. 11A illustrates an exemplary intervention assistant application interface;

FIG. 11B illustrates an exemplary tutor assignment feature of an intervention assistant application interface;

FIG. 12 illustrates an exemplary custom learning objects editor application view;

FIG. 13 illustrates an exemplary personal learning plan interface;

FIG. 14A illustrates an exemplary attendance view;

FIG. 14B illustrates an exemplary view of the performance interface;

FIG. 15 illustrates an exemplary view of the mode of learning interface;

FIG. 16 illustrates an exemplary view of a learning objects completion log for each one of the blended learning modes;

FIG. 17 illustrates an exemplary view generated by activating the intervention tab;

FIG. 18 illustrates an exemplary view generated by activating the checklist tab;

FIG. 19 illustrates an exemplary view generated by activating the messaging tab;

FIG. 20 illustrates an exemplary view of the personnel finder interface; and

FIG. 21 illustrates an exemplary table that calculates the number of lessons for different modes of learning based on different learning tracks for a student;

### DETAILED DESCRIPTION OF THE INVENTION

Various embodiments will now be described with reference to the accompanying drawings, which form a part of the description, and which show, by way of illustration, specific embodiments. However, this invention may be embodied in many different forms and should not be construed as limited to the specific embodiments set forth herein. Rather, these embodiments are provided so that this disclosure will be thorough and complete, and will fully convey the scope of the invention to those skilled in the art. As described below, various embodiments of the invention may be readily combined without departing from the scope or spirit of the invention.

The system described herein allows for the creation and automatic adjustment of online coursework using a repository of lessons and resources. As used herein, a “course” is the same as a class and is considered to be a series of related educational materials in a progressive order designed to teach a student about a particular subject matter. A “modularized learning object” is a particular topic or piece of educational materials that typically is self-contained, but may also build on other topics. It typically consists of an objective, a standard and an assessment, and is synonymous with the terms “lesson”, “module” or “exercise.” An “assessment” may be a quiz, exam, or test that is used to evaluate the knowledge of the student about the particular lesson.

The concepts disclosed herein may be implemented through software running on a computer. The computer may be any type of client device, including desktop computers, laptop computers, tablet computers, cell phones and any other device. The computer may be capable of establishing a communications link with the Internet, local area network or a wide area network through either a wired medium or wireless medium, and the computer may run an application program enabling the device to perform the programmed algorithms. The application for performing the algorithms of the invention as described below may be implemented on a standalone computer, or maybe implemented through several computers connected via a network. In one embodiment, the algorithms of the invention may be implemented on a central server, where the students access the system through remotely located client devices. In another embodiment, the central server operates in conjunction with a remote network device to perform the recited steps or constitutes the system. The steps or apparatus may be performed at either the server, the remote network device or through a combination of the two. The application programs are stored in physical memory devices, such as RAM, ROM, hard-drives, optical drives and any other non-volatile memory device. The client devices may include application programs that send and receive web-pages, web-based messages, and data packets having content for updating the program and display of the client devices. The client devices may have operating systems that enable the application programs.

Various aspects of the invention can be implemented in different ways. For example, the invention can be implemented through a traditional client server arrangement or a peer-to-peer network architecture. The application program can be implemented in client devices, network-devices or any combination of various devices. The client devices may run a thin-client application program. In one embodiment, the client application program may be executed through a web browser. The client application may be a browser plug-in that is activated on execution of the browser program or activated at a later time.

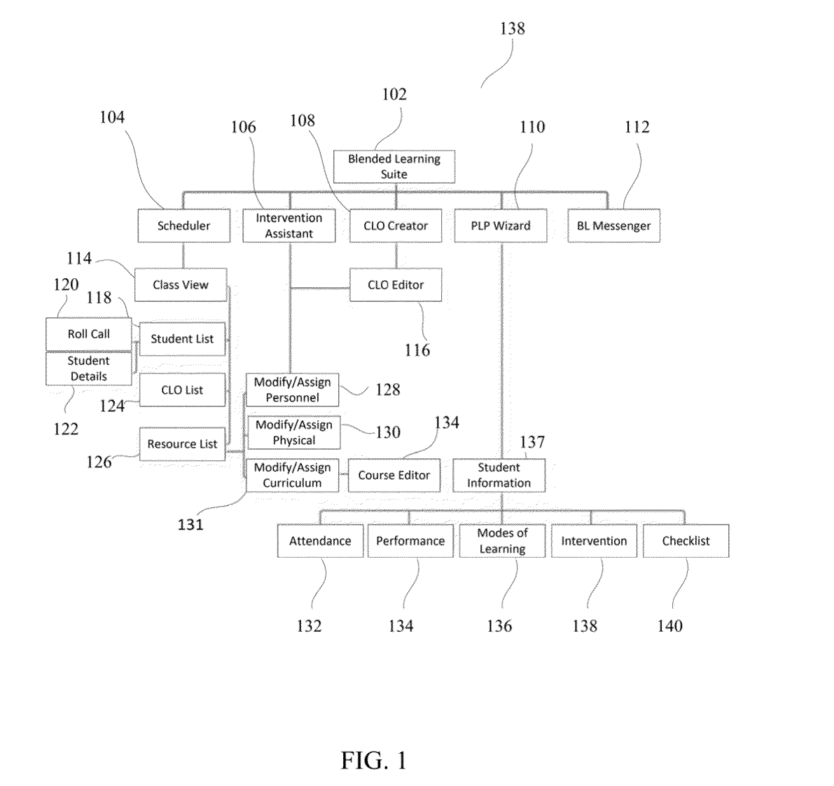

The general process flow of the blended learning suite (BLS) 102 is shown in FIG. 1. On entry into the system, the user is shown a homepage or dashboard. From this, the user may access other applications including scheduler 104, intervention assistant 106, custom learning object creator 108, personal learning plan (PLP) viewer 110, blended learning messenger (BLM) 112 and settings (not shown). The types of information displayed and accessible may differ based on the permissions and roles of the user. This set of applications would be typical for the role of a teacher. A learning coach user may only have the dashboard with personal plan viewer 110 and blended learning messenger 112. An admin user may have all of the same applications as a teacher but also have a personnel finder, while a student may only have scheduler 104, course delivery application (not shown) and blended learning messenger 112.

Scheduler 104 is anchored on a calendar view and provides class view 114. There are two different views or ‘modes’ for the class view 114. By default, class view 114 displays all the students grouped by the learning mode of the learning object they are assigned in the class, as shown by CLO list 124. They may also appear in labs or teacher led groupings. The other mode is student list 124, which shows the students in the class in a list, for example in alphabetical order. Student list 124 may show roll call 120 and details about the students as shown by student details 122. Resource list 126 interacts with intervention assistant 106. Intervention assistant 106 is triggered based on student assessments, for example, when a student incorrectly answers 5 assessment questions tied to the same standard indicator within the same lesson question pool. The user has the option of to modify or assign different personnel, curriculum or physical resources as shown by modify/assign personnel 128, modify/assign physical 130 and modify/assign curriculum 131. If the user chooses modify/assign curriculum 131, the user has the option of using course editor 134.

Custom learning objection creator 108 contains CLO editor 116 that may be used to edit the custom learning objects. Personalized learning plan viewer 110 allows the teacher to view the status of students for each personalized learning plan period. The information 137 may include attendance 132, performance 134, modes of learning 136, intervention 138 and checklist 140.

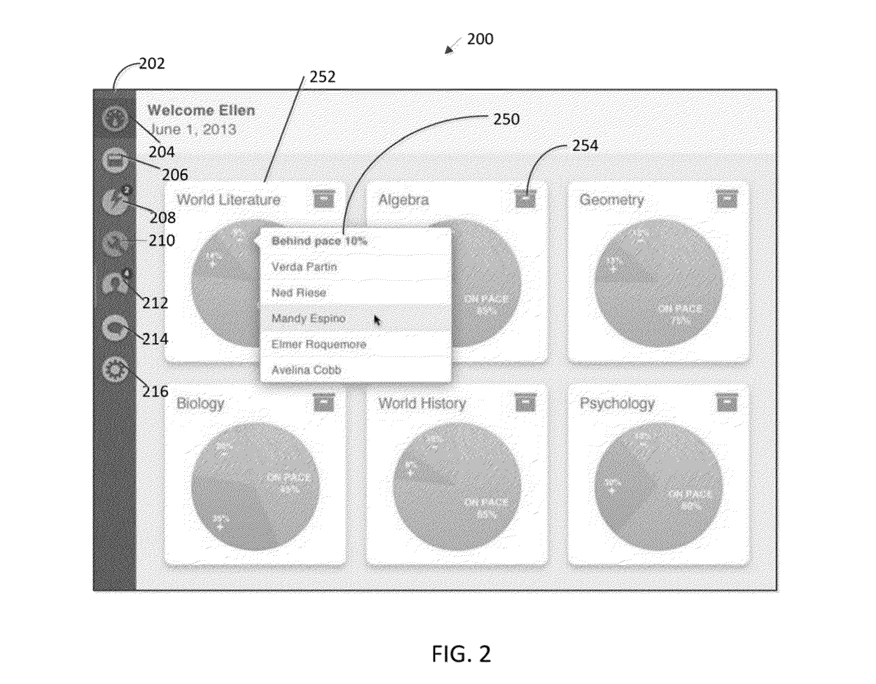

An example of dashboard 200 is shown in FIG. 2. Navigation between the various applications may be accomplished through navigation bar 202. Navigation bar 202 contains dashboard icon 204, scheduler icon 206, intervention assistant icon 208, custom learning object builder icon 210, personalized learning plan (PLP) viewer icon 212, blended learning messenger icon 214 and settings icon 216.

The dashboard 200 is presented to a user upon log-in. The dashboard 200 allows the user to quickly determine the status and progress of the group (or groups) under their oversight. Accordingly, the dashboard information graphics change depending on a user's credentials or privileges.

For example, when a teacher logs in, his or her dashboard view 200 displays class pacing information 250 by class. The pie chart 252 provides a quick overview of the percentage of students on pace, ahead of pace and those behind pace. Clicking on any given portion of the pie chart 252 displays a list of students within that pace group. Clicking on the student name in the list launches a student detail view that allows the teacher to review the learning material presently assigned to the student.

Additional information and info-graphics may be included to provide, among other features, a student's/classes' mastery of standards covered in a unit, lesson, and/or course.

In one embodiment, a Materials Bin icon 254 is located in the top right corner within each Class area. Clicking on the icon 254 displays a list of learning objects for students who will be working with content in collaborative learning mode, personal learning mode, conceptual learning mode, or a physical lab.

When working in other blended learning (BL) Applications, the teacher may return to the Dashboard view 200 by clicking on the Dashboard icon atop the Applications menu bar 202 on the left hand side of the BL Suite.

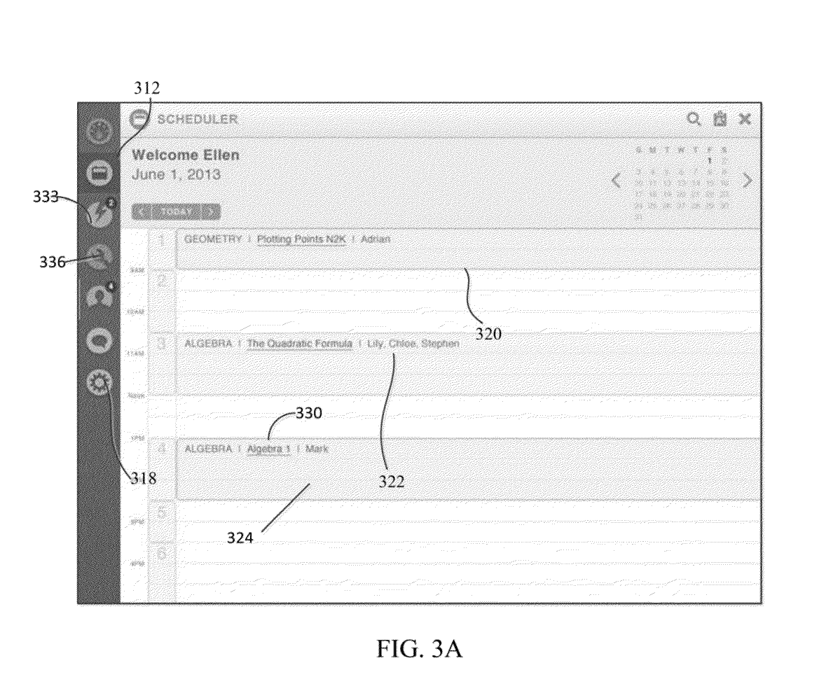

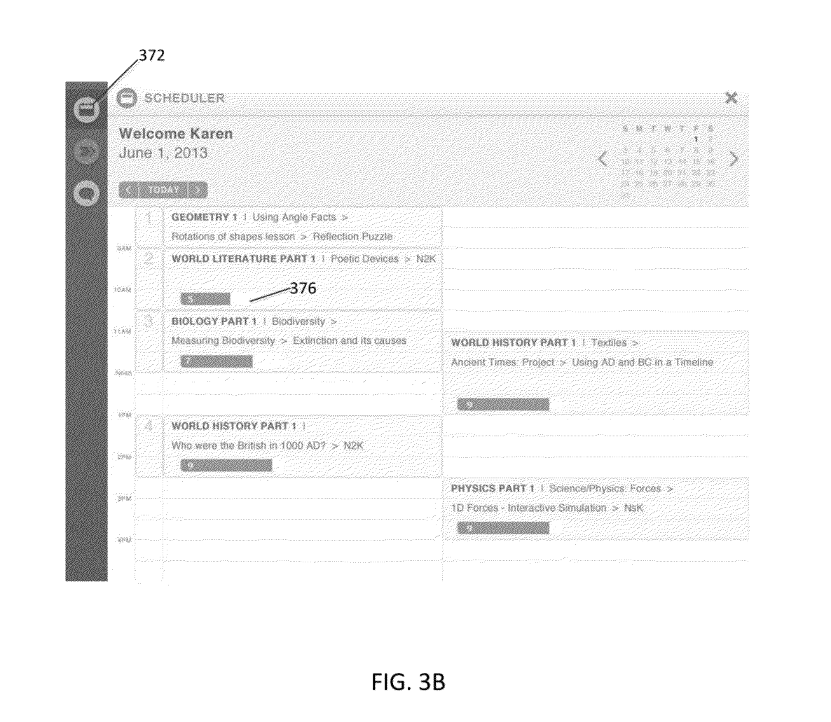

FIG. 3A illustrates a teacher's desktop scheduler view of an exemplary embodiment. The view is invoked by clicking on the scheduler icon 312. The teacher's name may be included in a welcome message, thereby indicating to the user that he or she is viewing the correct schedule. In the example of FIG. 3A, three events are scheduled: an 8 am appointment with Adrian 320, a 10:45 appointment with three students 322, and a 1 pm appointment with Mark 324. In one implementation, for tutoring sessions, a link 330 to the material to be covered is provided, thereby allowing the teacher to quickly review, or prepare for the tutoring session.

In the example of FIG. 3A, the system has auto-generated two new interventions, as indicated by the 2 over the Intervention icon 333. The teacher may click on the Intervention icon to access the relevant comments. These interventions 333 may not require the teacher's attention, and may be altered by the teacher. In one implementation, if an intervention requires teacher attention, the system places an exclamation point over the icon.

The example of FIG. 3A also illustrates that there are four PLP's for teacher review 336. These PLP's can be viewed upon clicking on the icon 336. The scheduler view may be closed and the user guided back to the dashboard view upon clicking the “X” in the upper right corner.

Students are able to view the synchronous classes in which they are enrolled on a calendar view. In this regard, FIG. 3B illustrates a student's desktop scheduler view of an exemplary embodiment. The view is invoked when a student clicks on the scheduler icon 372.

The student's ‘Agenda’ is listed for each class in terms of a start and finish time for that day. For each time slot, the learning object expected to be completed for that class is listed (e.g., “Reflection Puzzle” under “Geometry 1”). A progress bar 376 may be included as an infographic that allows the student to see how many lessons he or she has completed in the course. In the situation where a student has online classes, the time slot that his or her online instructor is available for each online course is displayed.

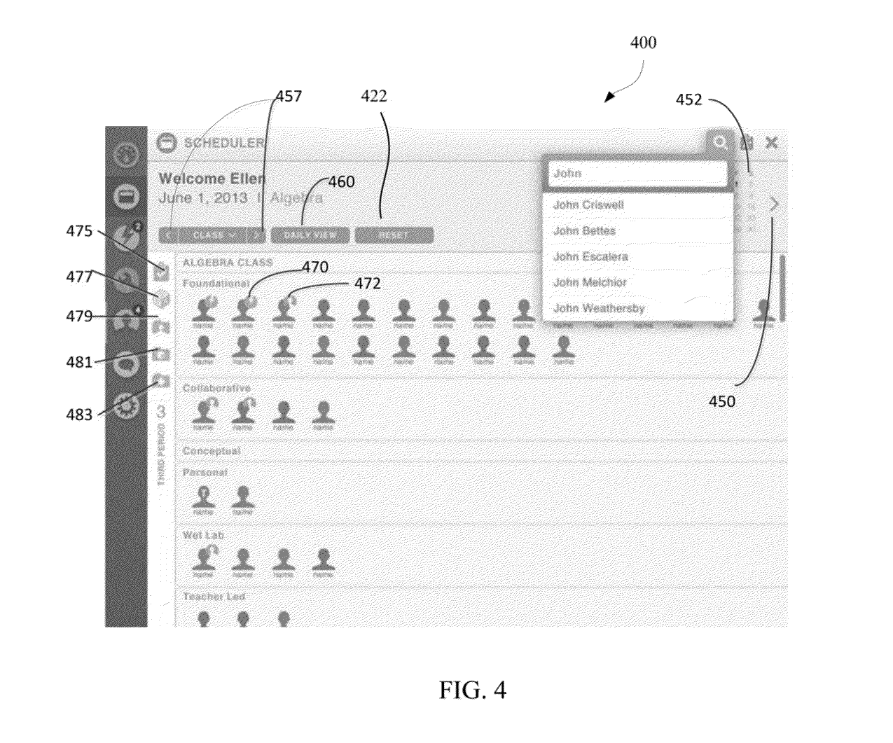

In addition to the calendar view discussed in the context of FIGS. 3A and 3B, the scheduler also includes a class view. In this regard, FIG. 4 illustrates an exemplary class view 400. The view 400 illustrates all the students in a given period and flags their icons with notifications, identifying whether they have interventions, tutoring, PLP issues, and the like. The teacher can navigate to different days by either using the arrows next to the date 457 to advance one day at a time, or select the specific day on the mini-monthly calendar 452 and use the arrows there 450 to change months. In one implementation, student photographs are displayed in the class view 400.

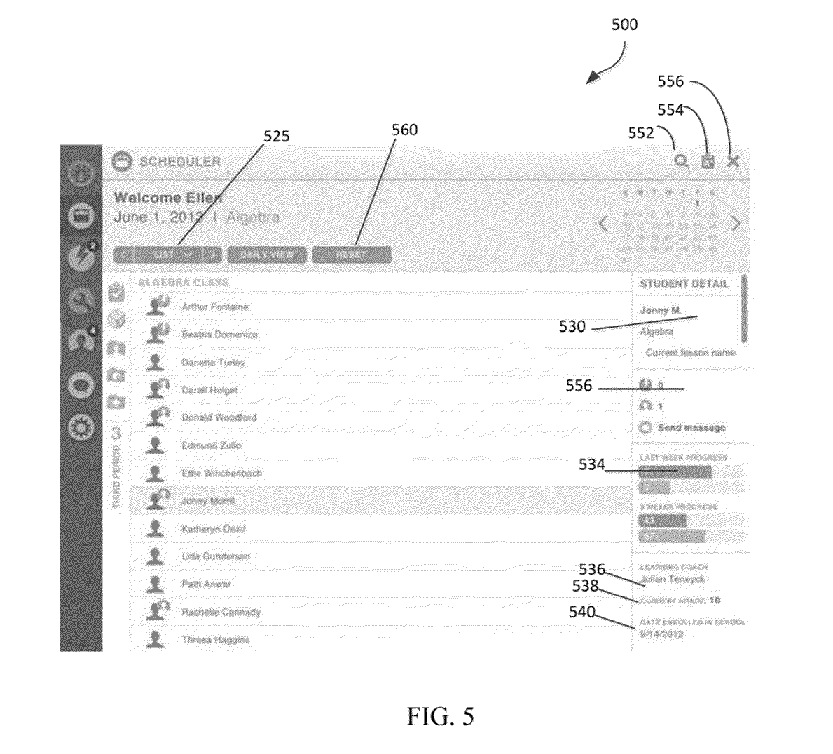

In one embodiment, in addition to the default class view that displays all the students grouped by the learning mode of the learning object they are assigned in the class, there is an additional “list view.” In this regard, FIG. 5 illustrates an exemplary list view. The teacher can switch between the two views by using the CLASS dropdown menu (424 in FIGS. 4 and 524 in FIG. 5). The list view 500 may provide additional information for each student, such as the student detail 530, interaction with the student 532, progress information 534, the name of the learning coach 536, the current grade of the student 538, and the date enrolled 540. In one implementation, student photographs are displayed in the class view. While the additional information for each student is discussed herein in the context of a list view of the scheduler, the same information may be available in the class view as well.

In the scheduler views discussed herein, (e.g., on the top right side) there are several icons: search icon 552, grade-book icon 554, and close scheduler icon 556. For example, the Search function in Class View provides a live search capability. As the teacher types in the letters of the student's name to locate in a larger class, the search feature provides suggested names of students that match the letters (as they are entered). The grade-book icon 554 invokes the grade-book of the teacher when clicked. Icon 556 closes the window to return to the dashboard view.

The “RESET” button 560 allows the teacher to re-assign the originally prescribed learning objects as determined by the Blended Learning business logic (which is based on Learning modes). The RESET 560 may be useful when a student or group of students is assigned the incorrect learning objects (e.g., Thursday's assignment incorrectly assigned on Wednesday). The RESET 560 by default reassigns the originally prescribed content to the entire class, unless a group or specific student is targeted first.

Throughout the BLS, different icons may be used to differentiate roles of users (e.g., teacher, administrator, student, etc.) and to indicate relationships to different Applications. For example, icons may be used to represent the Intervention and PLP applications. These same icons or symbols may be placed next to (or on top of) icons of students who may require Intervention or a PLP. These icons (or symbols) may be affixed or added to a student or teacher icon (even in cases where student and teacher photos are used in place of the generic icons) to indicate that the individual is also a tutor, a teachers' aide, or is only available online.

In one implementation, the icon (or picture) of a user is highlighted to indicate whether they are online, logged in, or offline. For example, a gray outline of the icon/picture indicates that the user is offline; a red outline indicates the user is logged in; and a green outline indicates that the user is online Logged in is different from online in that the user (e.g., student) may have logged in earlier in the day but is presently not actively using the system (and thus non online).

Referring back to FIG. 4, a teacher can click a predetermined number of times (e.g., twice) on an entry in the calendar view to transfer to the Class View for a selected time slot. The teacher may shift to a different period by using the arrows to the left and right of class 457.

The teacher can view other dates, by clicking on the appropriate day in the mini-calendar in the upper right 452. The teacher can return to the Calendar View by clicking the Daily View button 460.

The class view 400 organizes all students in the selected period into sections, based on what type of lesson they are assigned to. For example, if 20 students were in Foundational 428, 20 heads (with student names underneath) are shown in the Foundational section 428. Any students with active Interventions have an intervention icon attached 470. Students with active PLP issues have the PLP icon attached to their heads 472. In one implementation, intervention icons take precedence over PLP icons. If the student has personal time scheduled with the teacher, an aide or tutor, the view 400 tags their icon accordingly, as discussed above.

Clicking on a student icon brings up the student details panel. The teacher can drag a student's icon from one section to another, changing them from a Foundational lesson to a Collaborative one. The system then automatically adjusts that student's schedule and assigned lesson(s).

Class view 400 also includes a set of tools that are displayed to the left: roll call 475, custom learning object list 477, people resources 479, curriculum resources 481, and physical resources 483. Each of these tools and their functions are discussed in more detail below.

Dragging a student's name is similar to dragging an icon. Thus, dragging a name to Wet Lab causes the student's icon to disappear from where it was (e.g., Foundational) and moves it to Wet Lab. The system then alters the student's assignments and updates that student's scheduler accordingly.

Upon clicking on the roll call icon 475, a roll call view is displayed, which lists the students in alphabetical order. In roll call view, the teacher can edit information regarding the student's attendance. In one example, all students are marked as present by default. This allows the teacher to only edit information for students who are tardy or not present. A student may be marked “pulled-out” for students who are present, but may be taken out of the class for various reasons (e.g., special education). In each case, a second drop down menu may appear that defaults to “unexcused.” The teacher can then change this to “excused,” as appropriate.

In one embodiment, the teacher has the option of adding a note to each student with an excused Absence or Tardy, each day. To that end, the teacher may click on an active Note button. The note remains, even if the teacher later switches the student to Present or Unexcused.

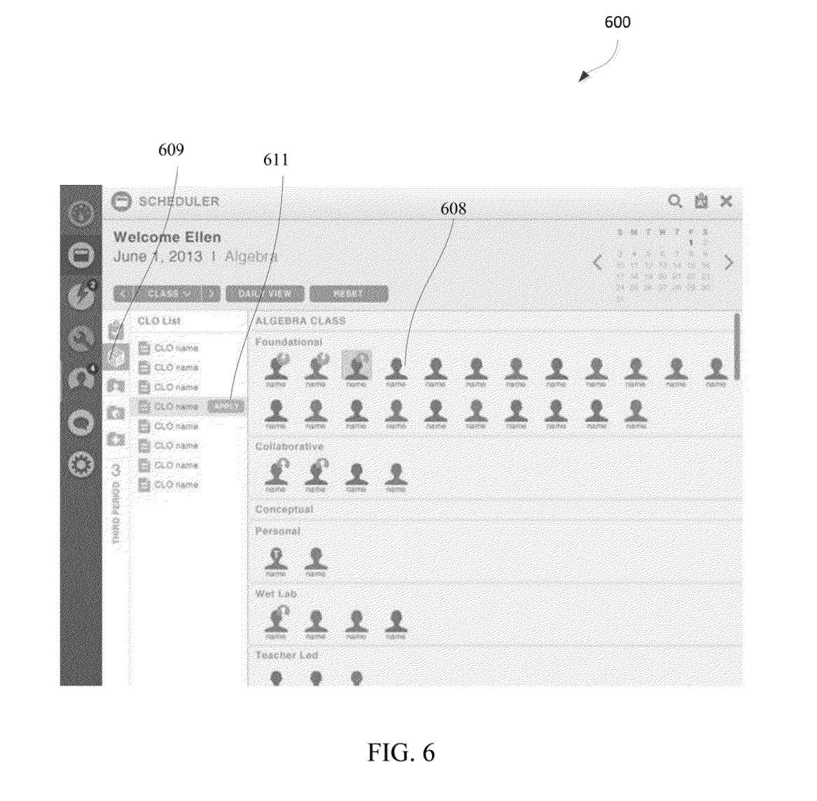

Clicking on the custom learning object (CLO) builder icon 609 opens up a CLO slide out. As illustrated in FIG. 6, the CLO slide out 604 includes all the CLO's written by the teacher for this period. To assign a CLO, the teacher can select a student, students, or a group. When a teacher clicks on the student(s) he or she would like to assign the CLO to, the teacher can select an appropriate CLO from the CLO list. An “APPLY” button 611 will appear. When the button 611 is clicked, a dialog box appears: “Would you like to assign the CLO?” The teacher can then affirm or cancel as appropriate.

A teacher selects a student or students prior to assigning a CLO. For example, the teacher can click on an individual student, click on multiple students, click on a Grouping title (e.g., Functional) to select that entire group, or click on the Class title to select the entire class. Of course, the teacher can click on a highlighted student (targeted) to deselect the student.

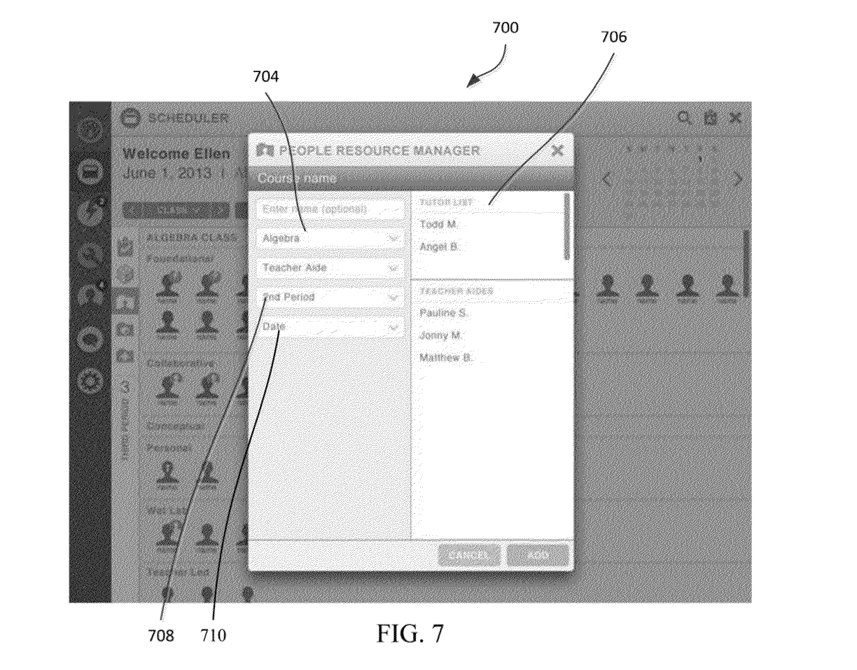

FIG. 7 illustrates an exemplary resource manager tool under a class view. The People Manager tool 700 allows the teacher to assign any number of individuals (e.g., teachers, tutors, online virtual tutor, aides, and the like) to a student or students, regardless of what learning mode grouping the student or students are currently assigned.

The tool 700 can be launched after a student (or students) is/are selected. The list of people can be expanded. However, in one embodiment, the “people” in the list must already exist within the system before a student is selected. The People Manager tool 700 uses filters to provide the user (e.g., teacher) the list of available resources. For example, when the topic 704 of “algebra” is selected, the system automatically eliminates from the display the resources that do not relate to algebra.

If the tutoring session is scheduled during a period other than the current class, time (e.g., period) 708 and/or date 710 filters can be used to further narrow the choices. If no date is chosen, the system automatically schedules the tutoring for a different time period (e.g., the next day/class). If the student or tutor is not available for the following day or class, the system may automatically search for the next available day/class for both student and resource (e.g., tutor).

When a teacher assigns a peer or student tutor, the mentee and mentor are notified via their scheduler. It should be noted that the student (mentee) has the ability to accept or decline the tutor assignment. Either way, the tutor's response is sent back to the assigning teacher (i.e., assignor).

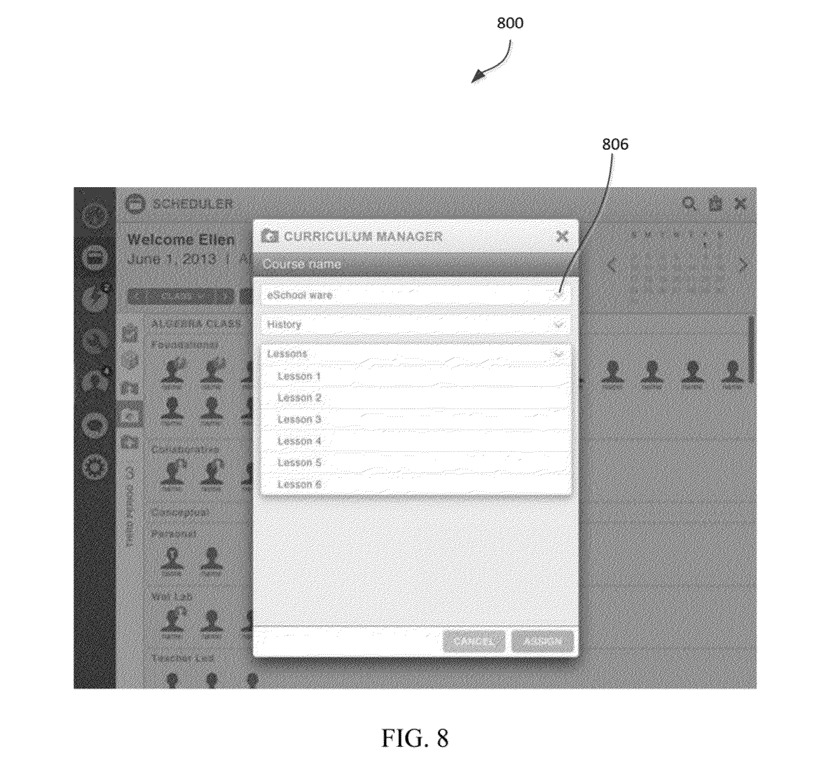

FIG. 8 illustrates an exemplary curriculum manager tool. The curriculum manager 800 allows the teacher to select from lessons available in the system. Items found in this category represent curriculum sources available for the teacher to assign to a student. For example, one or more of the following resources may be provided: Foundational Content (lessons and curricular assessments); Collaborative (lesson page); Conceptual (lesson page); Personal (lesson page); Formative assessments; and Diagnostics.

For example, a teacher may assign an electronic course (eCourse) lesson or open the Course Editor and modify the lesson before assigning it to the student(s). In one embodiment, the custom course is not persistent and exists only until the students complete the assignment. Thus, the curriculum manager does not create a CLO or alter the actual eCourse. In another embodiment, custom courses may be stored, like CLOs in a teacher's content library.

The Course Editor 800 displays the lesson(s) that make up the selected course, which are listed with expand arrows 806. In one embodiment, the Course Editor 800 allows a user to create a custom course with selected lessons. Further, the Course Editor 800 may allow the user to create a custom lesson using individual learning objects (in the course).

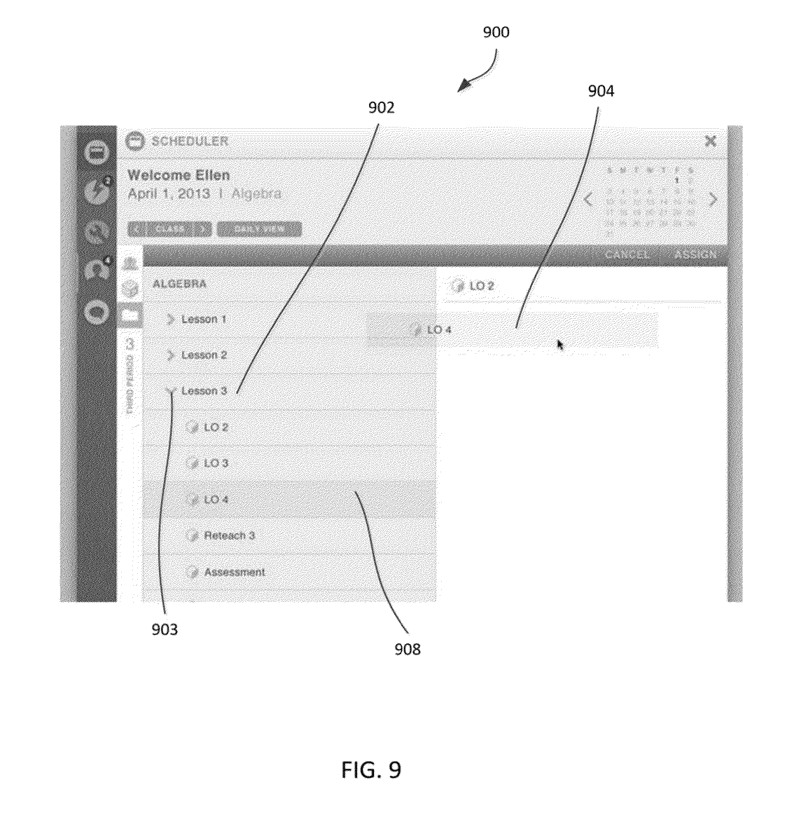

FIG. 9 illustrates a scheduler, consistent with an exemplary embodiment. The teacher can expand any Lesson 902 by clicking on the arrow 903 to display and select specific Learning Objects (LOs). The teacher may drag any LO 908 he or she wishes to assign to the students to the right side 904. In one embodiment, the course editor does not require the teacher to select a student or group first. Thus, a plan can be prepared before the student is assigned to the plan.

In one embodiment the customized LO 908 does not go to the CLO library. Rather, the customized LO 908 exists until the student completes the custom lesson. To assign the LO to another class, the teacher would recreate the LO 908. In another implementation, customized lessons are stored in a searchable library specific to its creator such that the edited course can be reassigned (in a way similar to how CLOs become part of an assignable library). Also, the edited course may have the option to be added to the gradebook, such that grades can be attributed and tracked for assigned and completed edited courses in the gradebook.

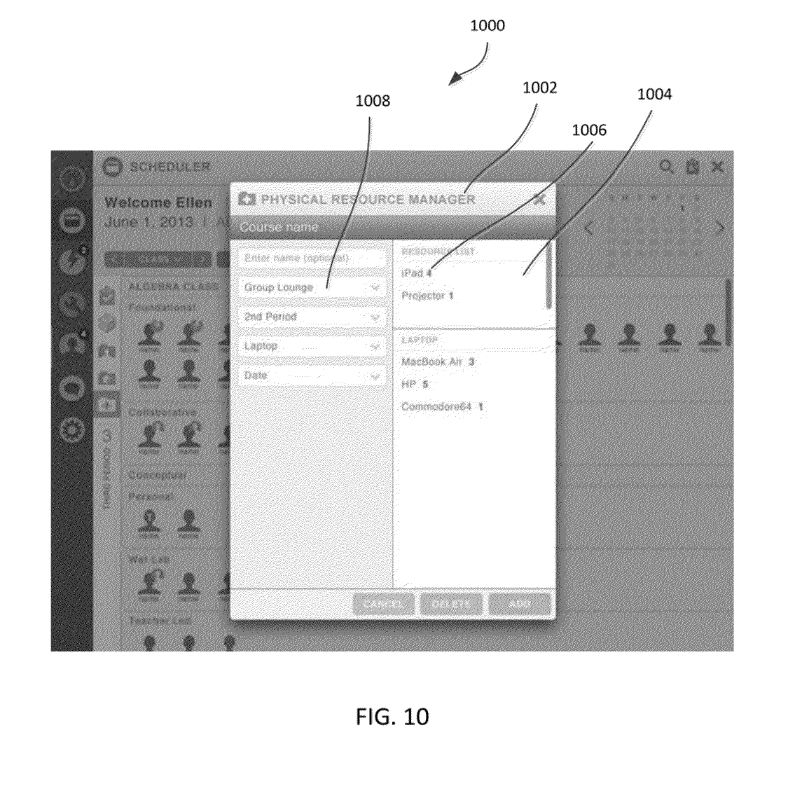

FIG. 10 illustrates an exemplary physical resources manager (which is different from the people resource manager discussed in the context of FIG. 7). In one embodiment, a student, students, or groups of students are selected prior to launching the Physical Resource Manager 1002. The teacher can then assign physical assets (i.e., resources) to the target individual or group. Administrators have the ability to add new physical resources. In one implementation, the teacher is free to assign the physical resources to students, but cannot supplement the list.

Physical resources are tagged as school-wide or class specific resources. School-wide resource can be floating resources (e.g., iPad, projector, etc.,) 1004. In one implementation, physical resources are restricted based on site location 1008. Conversely, if a physical resource is housed at one site, but can be shared between school sites, the availability is noted and accounted for in the Resource database and logic. The number of each resource 1006 may be listed next to the name of the resource.

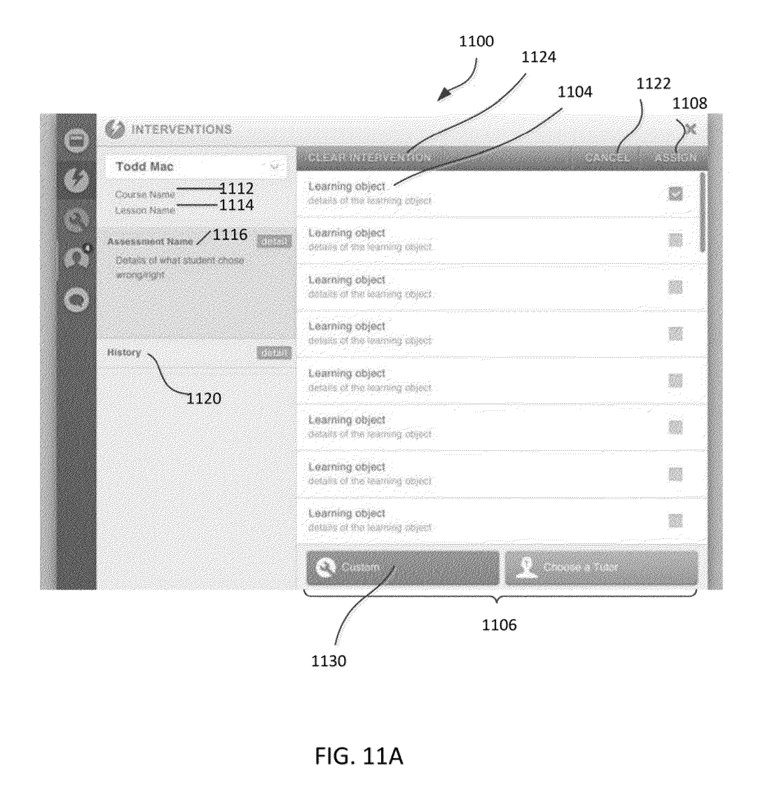

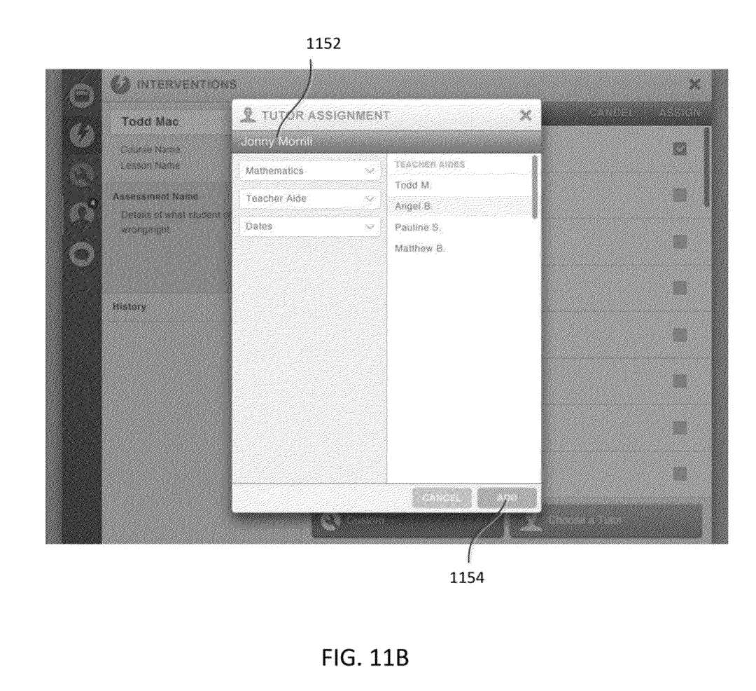

FIG. 11A illustrates an exemplary intervention assistant application interface 1100 of the BLS. If there are new Interventions, the system places a Notification number on the intervention app icon 1102. As soon as the teacher opens the Interventions App 1100 by clicking the intervention app icon 1102, the system clears the notification number. For example, the system triggers an intervention when a student incorrectly answers a predetermined number (e.g., 5) assessment questions tied to the same standard indicator within the same lesson question pool. When the student completes a LO linked to the intervention, the system gives the student a predetermined number of questions (e.g., 3) assessment. If this fails, the system generates a new Intervention. This repeats automatically until the teacher intervenes to assign a tutor, or until the system runs out of LOs to assign. Schools are able to set the threshold for the mini-assessments to define proficiency upon completion of different stages (e.g., 1/3, 2/3 or 3/3).

Upon clicking on the Intervention app 1102, the left column is populated with a list of interventions. New interventions may be separated by prior interventions (e.g., new interventions are above a separation line). In one embodiment, interventions with an exclamation point indicate that the intervention is new and the system has no more LOs 1104 available to assign to the student.

The right hand side 1106 remains blank until the teacher selects a student. The possible LOs that are available for the related standard are then populated on the right side 1106 in the form of a list. The app 1100 may pre-select one LO, which it then assigns to the student, unless the teacher alters the LO. The system assigns only one LO at a time. Thus, if the teacher selects a different Learning object, only that one is check-marked 1108.

Upon teacher selection of a student 1110 on the left, additional information about the Intervention may be provided. For example, the Course Name 1112 and Lesson Name 1114 indicate via a standard code the student is not passing. It should be noted that the standard code and state wording for the standard is displayed, for example, if is different from a “common core” wording. The Standard may be listed below the Lesson Name (not shown). The Assessment Name 1116 provides information regarding which assessment the student failed. Clicking the assessment link/button 1116 displays the most recent assessment questions and indicates whether the student passed or failed each assessment, respectively.

Clicking the History tab 1120 allows the teacher to view all interventions the student has with this course. The Cancel button 1120 closes the Intervention without making any alterations to the Intervention.

If the teacher chooses Clear Intervention 1124, the system assumes the student has passed the relevant standard. The system generates a confirmation dialog, such as, “Are you sure you wish to clear this intervention?” The teacher can then select “Yes” or “No,” accordingly.

When the student has no remaining LOs. The teacher may take at least one of the following actions: (i) create a CLO, (ii) assign a tutor, (iii) or clear the Intervention.

Instead of assigning a LO, the teacher may select a tutor as illustrated in FIG. 11B. The filters default to the pertinent course. The teacher may then select a tutor 1152 and click on the ADD button 1154. The system then updates the schedules of the student and the tutor.

Clicking on the Messaging icon (not shown in FIG. 11B) opens a Messenger with that Tutor's name already pre-populated in the conversation window. Accordingly, the teacher can communicate any notes, instructions, or directions to the tutor.

Clicking the Custom button 1130 directs the teacher to the CLO App, where the student's name, course name, and lesson name in connection with the pertinent standard is pre-populated. When the teacher completes a new CLO, the teacher can return to the Interventions view 1100 and see the entries on the LO list on the right.

The exclamation point next to a student's name indicates that there are no more LO's related to the given intervention standard available in the system to assign to the student, and therefore, the student requires immediate tutoring. Upon completion of tutoring by the student, the exclamation point is removed by the system. If the teacher assigned a tutor, then no LO is checked. If the teacher created a new CLO, it is displayed in the list and checked 1108 accordingly.

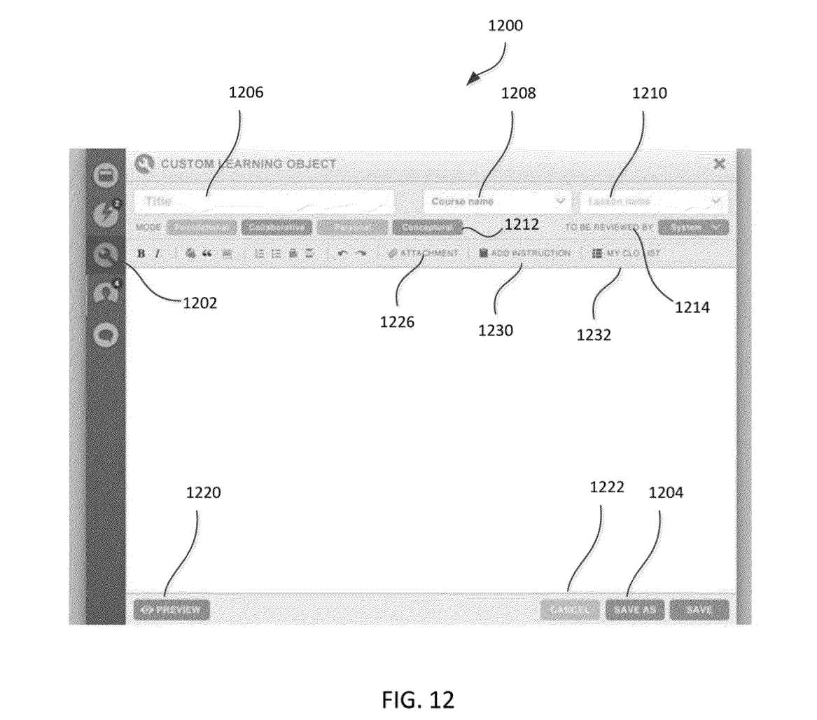

FIG. 12 illustrates an exemplary custom learning objects (CLO) application view, which can be invoked by selecting (i.e., clicking) the relevant CLO. Alternatively, a teacher can invoke the CLO view 1200 via the intervention application discussed above, or by simply clicking on the CLO icon 1202 from any view.

The CLO interface 1200 can be edited (even if pre-populated) and saved 1204 in a memory of the computer running the software to create a new CLO. The CLO interface 1200 includes a title (e.g., name of the CLO), course 1208, and lesson name 1210.

In one embodiment, the next row from the top includes buttons for each of the four blended learning modes 1212, namely foundational, collaborative, personal, and conceptual. In some embodiments, the conceptual is placed in the same learning mode as collaborative, thereby resulting in three modes of learning. The system may select Foundational by default. In one embodiment a CLO can be tagged with multiple modes.

The “to be reviewed by” button 1214 defaults to System. Accordingly, the system generates an assessment and passes or fails the student based on the assessment. Alternatively, the review button 1214 may be adjusted to “Teacher,” who must manually review the lesson and clear the intervention when he or she feels the student has passed the lesson.

In one embodiment, CLO creators are able to search their CLO List by code, tag, and/or keyword. Existing learning objects are editable and savable as a new version. For example, the teacher may click on a CLO from his or her CLO library, make adjustments, and SAVE (or SAVE AS) 1204 to create a new CLO or just update an existing CLO. In one embodiment, CLOs can be added to the grade-book, such that grades can be attributed and tracked for CLOs in the grade-book.

The Preview button 1220 allows the teacher to view the formatted lesson. Selecting “Cancel” 1222 removes any selected CLOs ready to be assigned. The buttons “Save” and “Save As” 1204 save the CLO into the CLO library that is visible in the Class View.

Selecting the Attachment button 1226 from the Editor line opens a standard operating system (OS) based user interface (UI) for viewing and finding files. This UI allows the teacher to navigate (e.g., search) their computer system for a relevant file. The Add Instructions button 1230 opens the notepad functionality, similar to Roll Call and PLP. Thus, a note can be attached to the CLO, allowing users to view the additional instructions.

The My CLO List button 1232 slides out the CLO library, similarly as in the Class View. The teacher can select a CLO and populate the Creator. The teacher can then edit and Save 1204 over the previous version, or Save As 1204 and create a new CLO. Any new CLOs immediately appear in the list.

The system described herein generates notifications at the end of each PLP period (e.g., 10 school days) to flag students who fail to meet all their goals in one or more classes. The system also flags the students that are due to have their PLPs reviewed and tracks which lessons and CLOs have been assigned. By selecting the PLP app, the teacher can view for each student which goals were not met and in which class(es). The teacher (or learning coach) can then further investigate using the system described herein based on the details and the specific goals for a particular student or group.

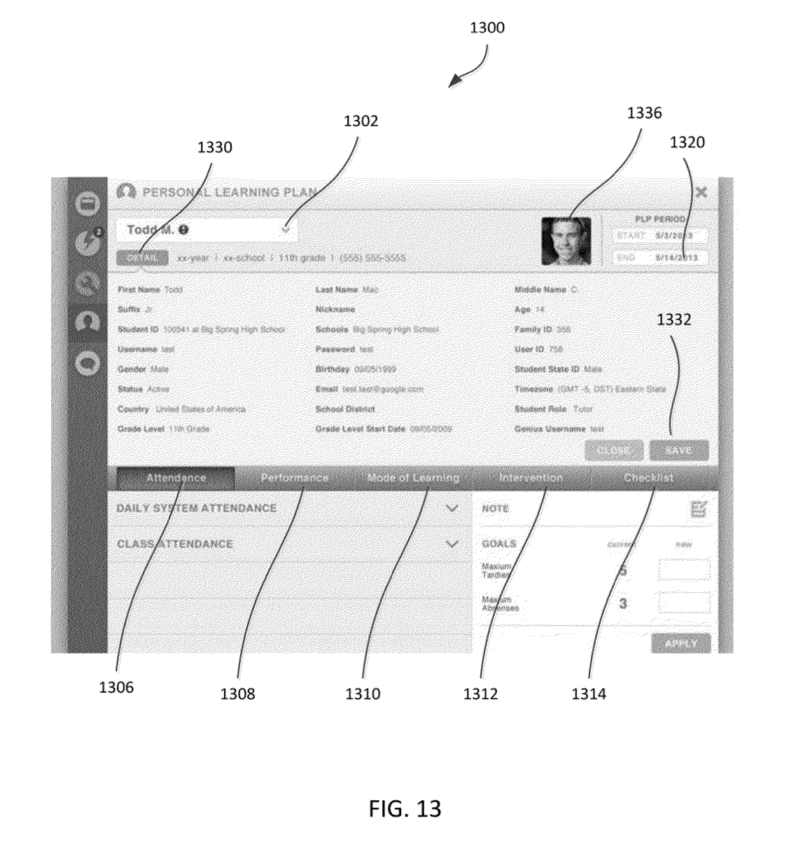

FIG. 13 illustrates an exemplary personal learning plan interface. A teacher may use a drop down name menu 1302 to select a student. In one embodiment, students not meeting predetermined criteria (“goals”) are on top. Goals are grouped into one of five categories: Attendance 1306, Performance 1308, Modes of Learning 1310, Intervention 1312, and Checklist 1314. Teachers are allowed to add notes. In one embodiment, teachers do not have permissions to set Goals. Learning Coaches can edit details and set the next PLP period goals.

There may be a snapshot feature to capture the data for a particular section in PLP. The teacher may have spreadsheet reporting capabilities for data shown in PLP, with the name students in rows and data points in columns (within specified date ranges 1320). There may be an “email” and “download PLP” button available (not shown) such that the learning coach can send a student's parent the PLP even before they do the PLP call with the student. Teachers are also able to send out an update email after the PLP call.

The admin is able to control the level of involvement for PLP's by turning on/off features and alerts. The Admin can change the Personal learning plan name toggle on and off the tabs.

The modes of learning algorithm may provide guidance for schools that do not necessarily want to use a PLP, by providing recommendations to change the curriculum track(s) for students and groups.

The student details 1330 may get pulled from eSchoolware, but the Learning Coach could edit the fields, and Save 1332 the changes. The system operates as a “wizard” for the learning coach. Once the coach has chosen a student, the system steps the coach or teacher through each tab in turn, starting with attendance 1306. A profile picture 1336 of the student may appear at the top right corner of the PLP Student Detail 1300.

The Student Detail shows both grade to date and a non-running total in PLP. Each PLP tab will have a number next to its name indicating the number of alerts for that tab. For example, “Performance (3).”

In various embodiments, every email address may include a “mailto” link set. Clicking on such link invokes the default mail client for the sending user. Upon hovering over a phone number in Student Detail, it is revealed whose phone number it is (e.g. parent's cell, student's cell, etc.). The student's age 1370 is displayed at the top of the PLP. A warning will may be displayed if the contacting parent is with respect to a student who is 18 or older (due to privacy).

The Learning coach and Admin have a dashboard view of the student PLP status. The PLP may be reviewed biweekly, monthly, quarterly, and annually with a historical view on how students have been doing with the PLP. At the end of the year a summary record of the PLP may be provided.

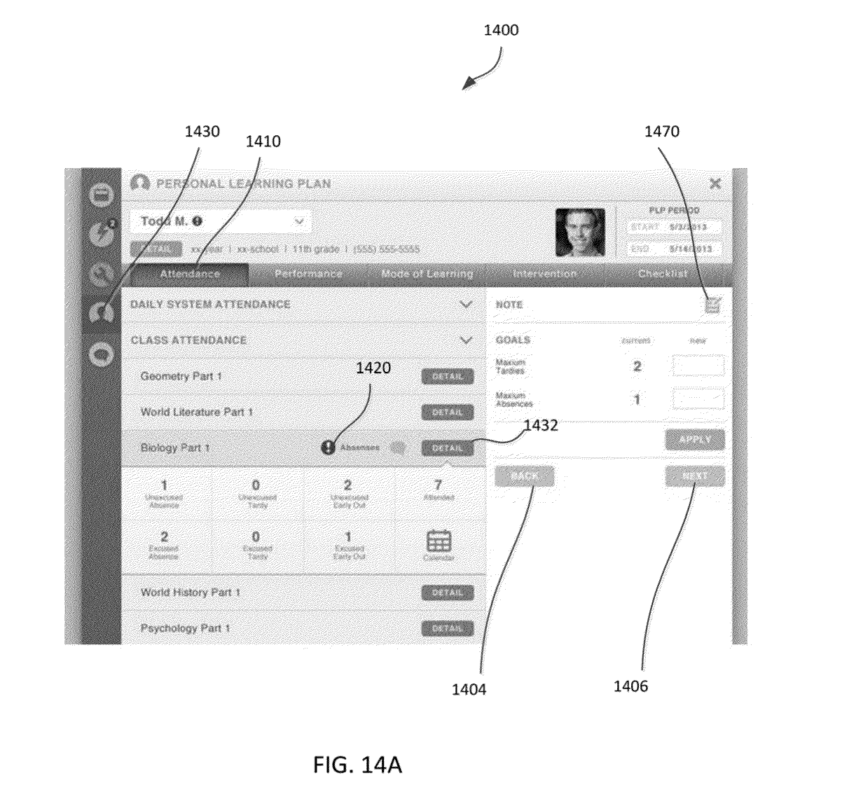

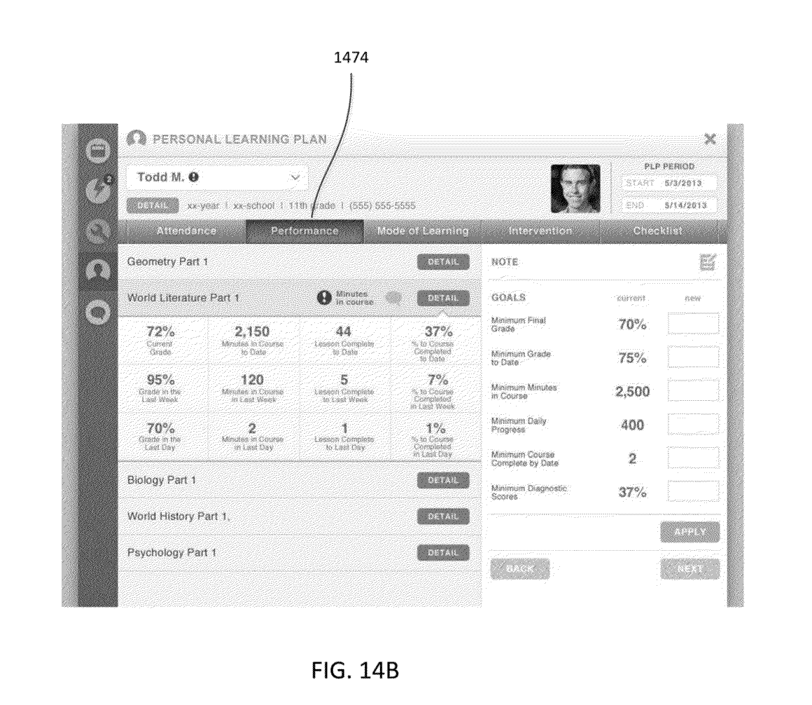

Both the teacher and the learning coach can navigate the tabs by using next 1404 and back 1406 buttons, as illustrated in FIG. 14A. A teacher may suggest changes to student details from the PLP or the student details screen. The student may also set goals for themselves when viewing the PLP, thereby taking a more active role in the process.

In one embodiment, in addition to student detail at the top level of the PLP) there is a dashboard for the PLP that includes an overview. For example, it illustrates both information reflecting both the strengths and weaknesses of the student (thus, the interface does not just flag concerns). This is particularly helpful for students who review their PLP, and are able to see their progress and areas where they would benefit from improving.

From the attendance tab 1410 illustrated in FIG. 14A, a user (e.g., teacher) can quickly ascertain attendance information for different classes (i.e., subject matters such as geometry, literature, history, etc.). The ability to alter and implement goals lies with the learning coach. The goals section indicates whether the goals are being met. Each class tracks attendance in class through Roll Call, and the eSchoolware system software, discussed herein, through monitoring activity online.

By way of example, FIG. 14A illustrates that the student has an absence concern in biology 1420. The learning coach has several options to address this concern. Each class line has a messaging icon that can be clicked to invoke a Messaging App 1430 to facilitate a communication with the pertinent teacher, administrator, and/or parent. Thus, the learning coach may select one or more individuals to whom to send the message to by clicking on the corresponding check box(es).

The Detail button 1432 populates the information tracked for this panel (e.g., biology part 1 in the example of FIG. 14A). The learning coach can click on the Note Icon 1470 and document the absence issue. Each panel has its own notes and the system saves previous PLPs and their corresponding notes.

The learning coach may alter the Goals for the student based on the absence concern. The system automatically uses the goals for the previous PLP, which may be altered by the learning coach. The system evaluates goals at the end of the PLP period. The system includes default goals for the first PLP period. Accordingly, users (e.g., learning coaches do not have to create or alter the goals section but have an option to do so).

In one embodiment, in addition to Class Attendance, the system also tracks System Attendance, monitoring whether the student logs into the system discussed herein at appropriate predetermined times. For example, the system tracks the details such as: time spent in class each day and daily system attendance. The detail panel 1432 also may display attendance and hours logged in.

FIG. 14B illustrates an exemplary view of the performance interface. In various embodiments, the interface can be invoked by clicking on the performance tab 1474 or is invoked by clicking on the Next tab 1406 (in FIG. 14A). The coach is able to set performance goals based on various parameters, grades, and percentages for each class or an aggregate of classes. For example, a coach may set the goal for a student currently averaging below 80% on his assignments in a class, to improve to a percentage over 80% by the end of the PLP period. In one embodiment, trending information and indicators (e.g., +4% since last PLP period) is included in the PLP application described herein.

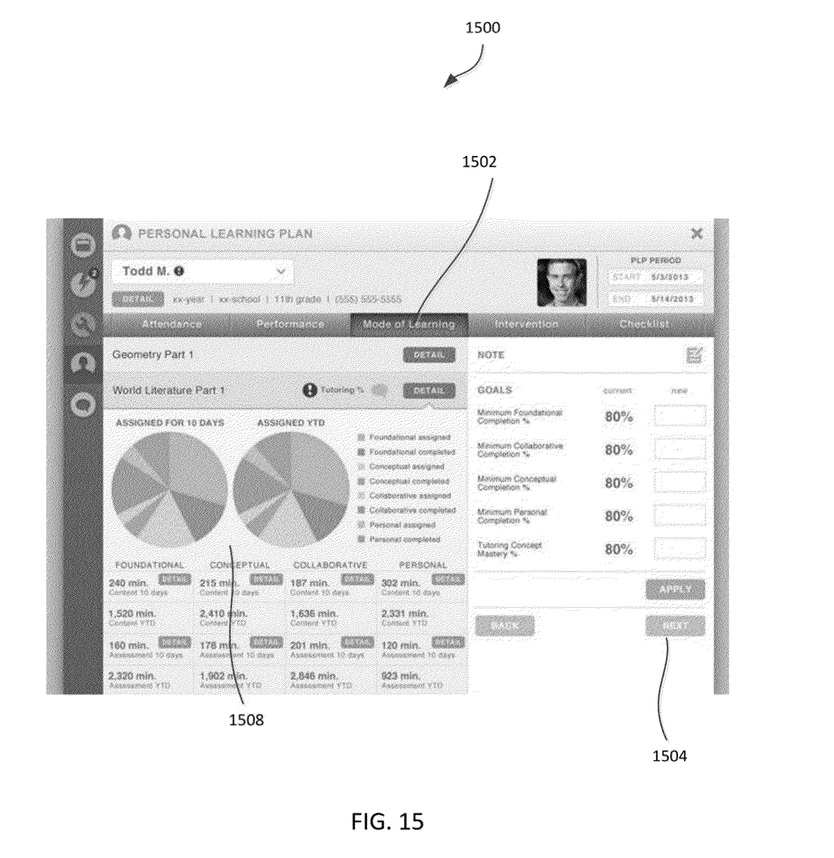

FIG. 15 illustrates an exemplary view of the mode of learning interface. In various embodiments, the interface can be invoked by clicking on the mode of learning tab 1502 or the “next” tab 1504 after completion of the performance evaluation. This interface may include pie charts 1508 illustrating the breakdown of the assigned and completed lessons for each of the four modes of learning. One chart is for the current year, the other for the current PLP. Hovering over a pie displays the percentages in number format.

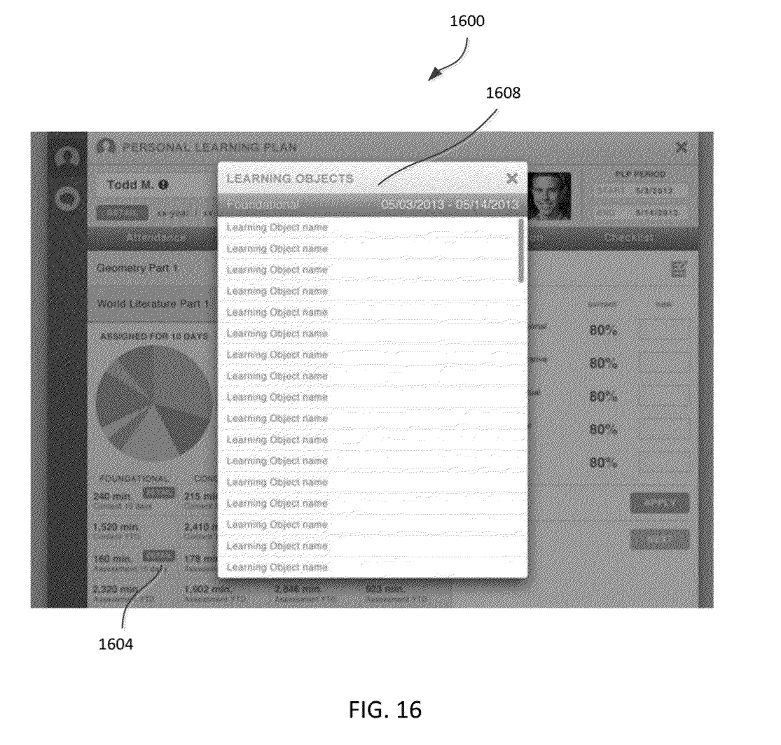

FIG. 16 illustrates an exemplary view of learning objects for each one of the four blended learning modes selected (e.g., foundational, collaborative, personal, and conceptual). In the example of FIG. 16, the learning objects for the foundational learning mode 1608 is displayed. It appears when a teacher selects content detail 1604. If the teacher selects Assessment detail, a list of pertinent Assessments is displayed. Date completed information will be listed next to each completed Learning Object. In addition, clicking on the arrows to the left or right of the current PLP date allow the Coach to review the completed LO information for previous PLP periods.

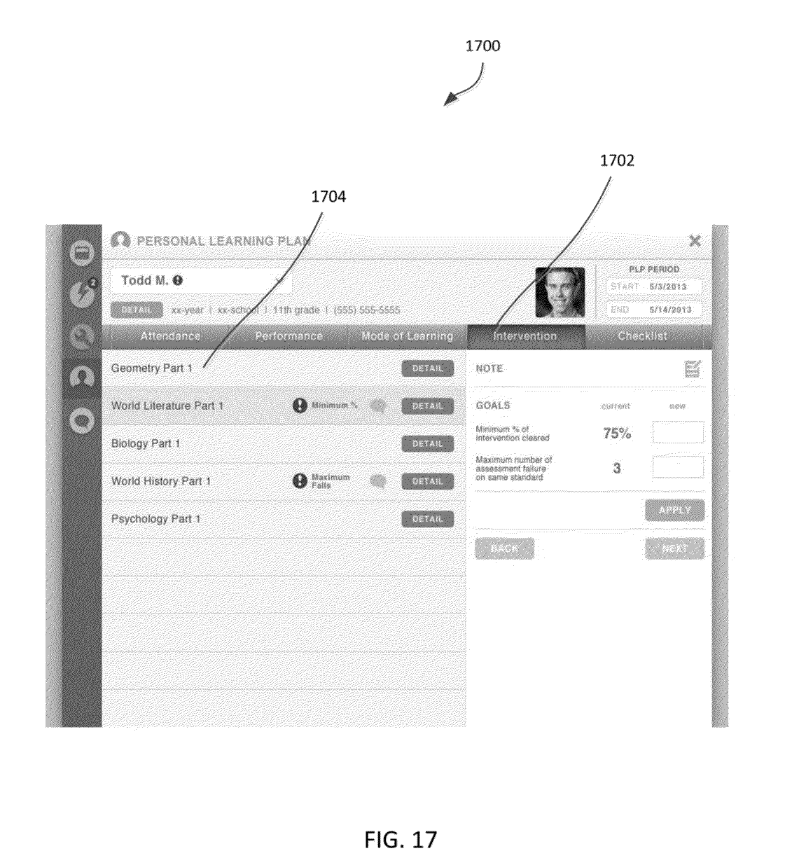

FIG. 17 illustrates an exemplary view generated by activating the intervention tab 1702, which provides monitoring information on how well the student is doing with respect to the intervention goals. The coach has access to the Tutor manager tool and is able to assign a tutor as appropriate.

The intervention view 1700 displays the most recent assessment results and provides technical detail about the assignment(s) and intervention involved. The intervention lesson title may be displayed. When clicked, it launches the content delivery system that allows the Coach to review the Lesson failed. As in other views discussed herein, an exclamation point highlights that the student is not meeting a goal.

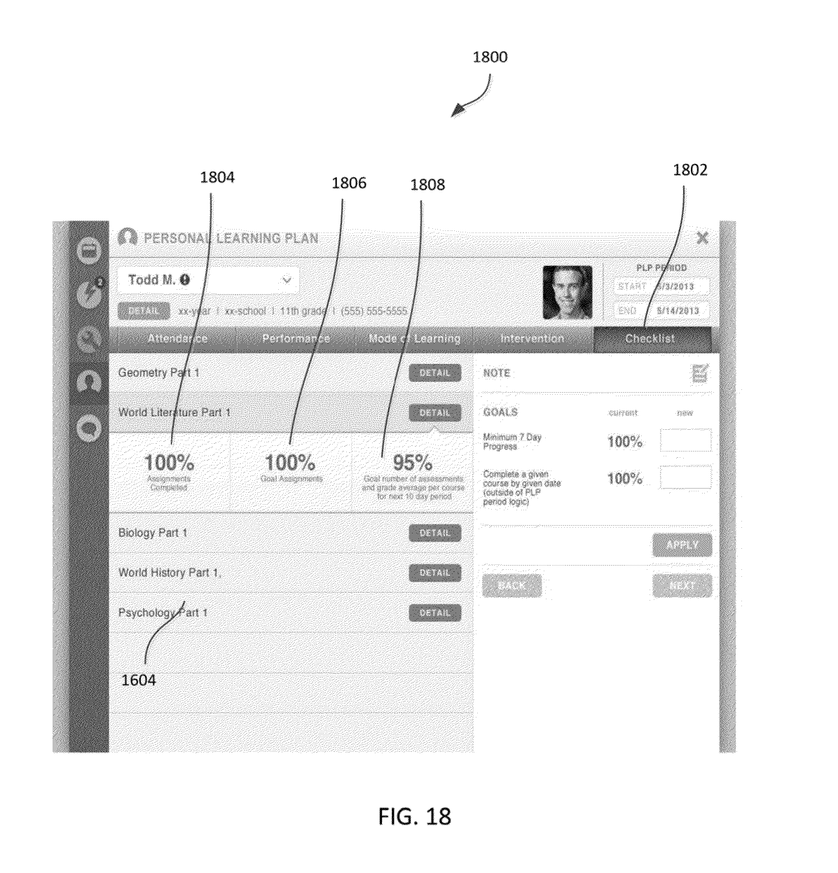

FIG. 18 illustrates an exemplary view generated by activating the checklist tab 1802. The checklist view 1800 may include graduation requirements (that may be client specific), percentage of assignments completed 1804, goal assignments 1806, goal number of assessments 1808, and grade average per course for a forward looking predetermined number of days (e.g., 10 day period). In various embodiments, pacing and/or progress type goals may be replaced with actual raw numbers, (e.g. “11/15 Assignments Completed.”) Pacing tabs (not shown) may be included, which illustrate milestones for lessons.

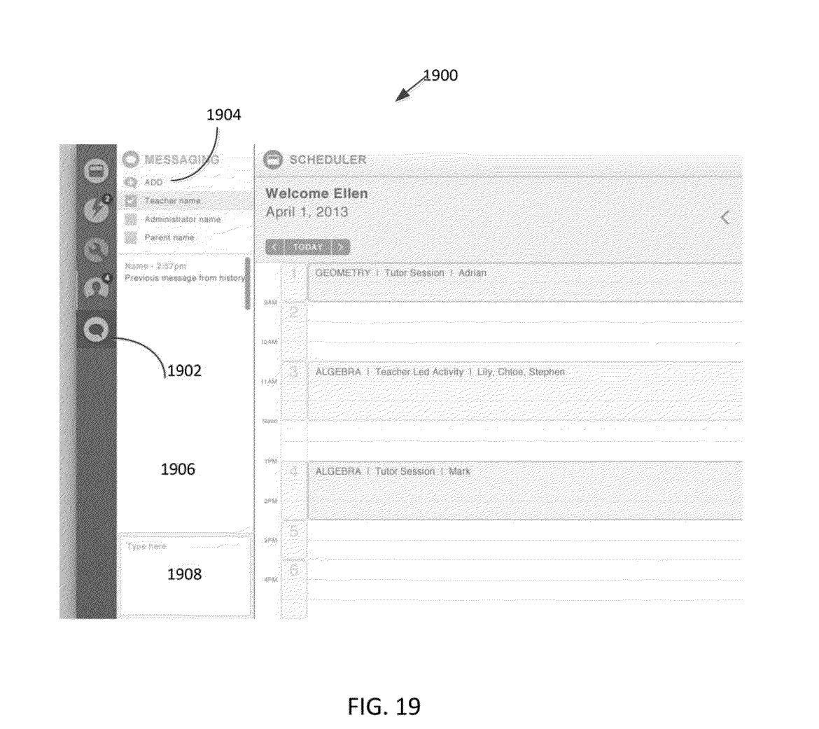

FIG. 19 illustrates an exemplary view generated by activating the messaging tab 1902. The messaging view 1900 displays a list of names people the teacher communicates with through instant messaging (IM). The add button 1904 brings up a search interface to allow the teacher to identify a name with whom to communicate with via IM. In various embodiments, the messaging view 1900 may display whether searched users are online or offline.

Upon name selection by the teacher, the central portion 1906 of the display may illustrate any previous posts within a predetermined period (e.g., last 30 days). At the bottom portion 1908, the user (e.g., teacher) may enter the message, which is transferred to the central section 1906 and sent to the recipient. When new messages appear, the Messaging Control will have a number above it (similar to the PLP and Intervention controls in prior exemplary views).

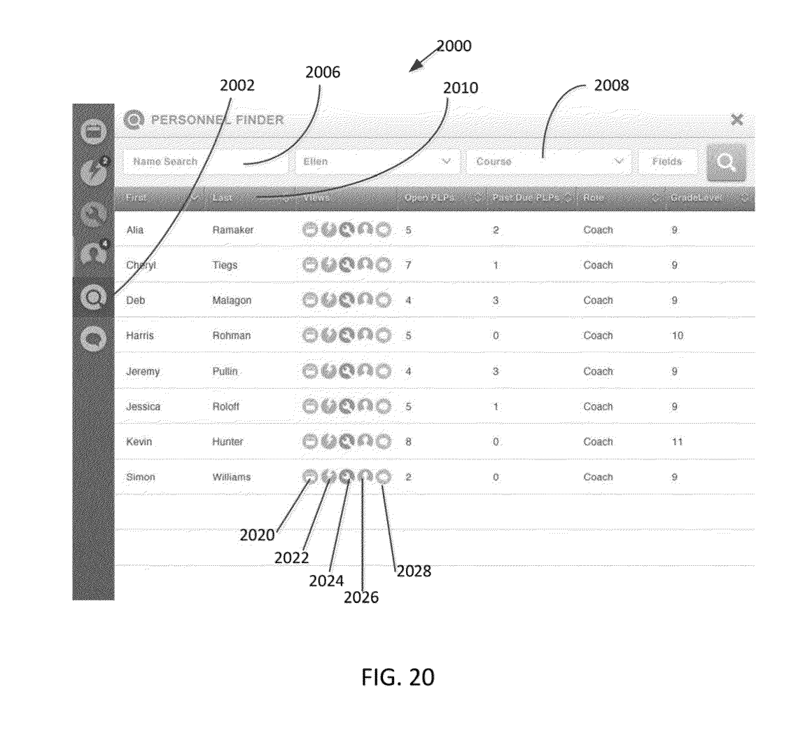

In one embodiment, there is a personnel finder application that allows an administrator to locate teachers, students, etc. via filters. To that end, FIG. 20 illustrates an exemplary view generated by activating the personnel finder button 2002. An administrator can use the name search field 2006 if he or she is uncertain of the teacher's last name or the exact spelling. Alternatively, the Administrator may use the Course Pulldown menu 2008. When a course is selected, the name of the teacher(s) or student(s) in that course is automatically populated in the name pull down menu 2010.

In the example of FIG. 20, to the right of the located teachers, are several icons (i.e., 2020 to 2028). That teacher's schedule 2020 invokes the scheduler app to illustrate the teacher's schedule. The teacher login times and time spent in system is also displayed.

The interventions button 2022 invokes the intervention app, which illustrates the interventions assigned to that teacher. The CLO library button 2024 invokes the CLO for that teacher. The next button 2026 invokes the PLPs. The Messaging app icon 2028, facilitates electronic communication between the administrator and the teacher (e.g., via IM).

The system discussed herein may (automatically or interactively with a teacher, coach, etc.,) adjust the learning content provided to a student in the on-line e-learning environment. For example, a series of custom learning objects may be displayed through the course delivery system that forms at least part of the e-learning course. As discussed above, the series of custom learning objects have a mix of modes of learning, namely (i) foundational, (ii) collaborative, (iii) personal/tutoring, and (iv) conceptual. In some embodiments, the conceptual is placed in the same learning mode as collaborative, thereby resulting in three modes of learning.

The proficiency of the student relating to the content of the custom learning is assessed by the BLS program. A revised mix of percentage of the time to be allocated for each mode of learning with respect to the overall learning time allocated for all the modes of learning for the student is determined based on the assessment of the proficiency of the student for the custom learning objects. A new series of custom learning objects is ultimately displayed through the course delivery system, where the additional custom learning objects are based on the revised mix for the modes of learning.

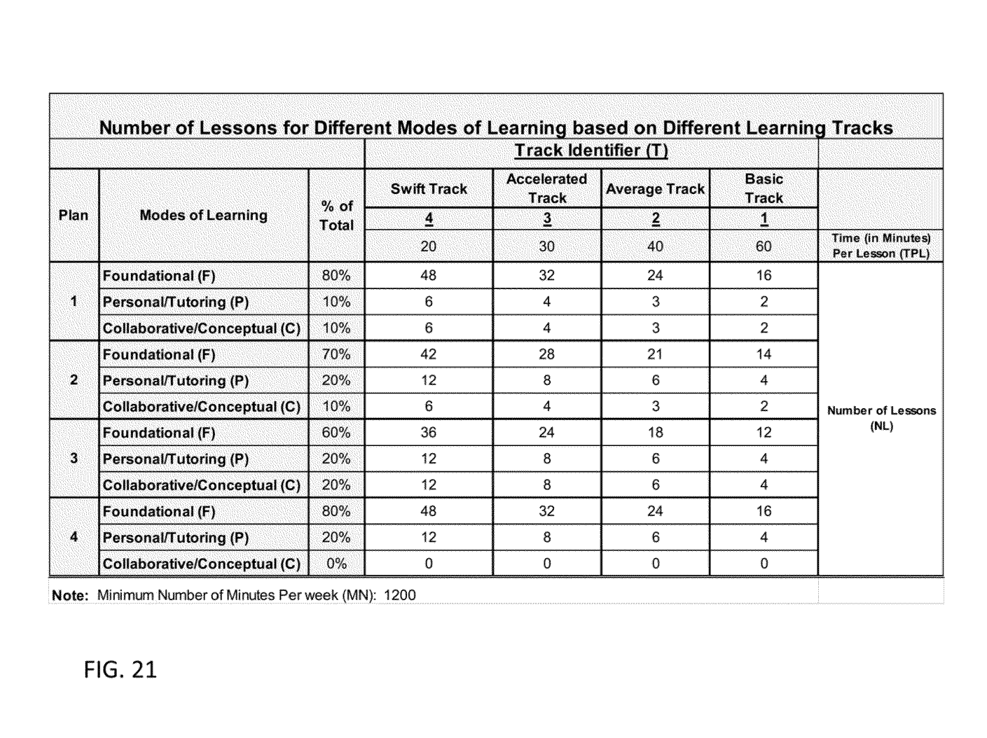

Perhaps it would be helpful to now discuss the automatic adjustment of the learning content by way of an example. To this end, FIG. 21 illustrates an exemplary table that calculates the number of lessons for different modes of learning based on different learning tracks for a student. In the example of FIG. 21, there are several learning tracks, namely (i) basic, (ii) average, (iii) accelerated, and (iv) swift. The basic track may be for students who are better accommodated with more time per lesson. It has a predetermined time per lesson (TPL) (e.g., 60 min). The average track represents the default track, which has a predetermined time per lesson that is shorter (e.g., 40 min) than the basic track. The accelerated track has a predetermined time per lesson (e.g., 30 min) that is shorter than the average track. The swift track has a predetermined TPL (e.g., 20 min) that is shorter than the accelerated track.

It should be noted that for a fixed minimum allocated learning time for a predetermined period (e.g., 1200 min per week), there is an inverse relationship between the TPL and the number of lessons (NL) allocated for the learning modes. Put differently, if the time for each lesson is shorter, then there are more lessons to meet the net time allocated for each learning mode. Such approach better accommodates different needs and learning capacities. For example, some individuals may have a shorter attention span or may have a schedule that does not allow 60 minute classes. In this regard, a swift track (e.g., with 20 min) would be more appropriate than the basic track (e.g., with 60 min). The tradeoff is that an individual on the swift track has three times as many sessions as the one on the basic track.

By way of (non-limiting) example, in the example of table in FIG. 21 it is assumed that there is a 1200 minimum total learning time allocated for the student (MN=1200). This time is divided into different modes of learning, namely (i) Foundational (F), (ii) Personal/Tutoring (P), and (iii) Collaborative/Conceptual (C). The total minutes between the different modes of learning add up to the minimum assigned for the week (e.g., 1,200 minutes). For example, under the first plan, 80% of the time is Foundational, 10% Personal/Tutoring, and 10% is Collaborative/Conceptual. Thus, the minimum net time for the first plan totals to 1200 minutes between the different modes of learning in the example of FIG. 21. Equation 1 below summarizes the time relationship between the different modes of learning:

F+P+C=1 (Eq. 1)

Where:
F is the percentage of time for foundational learning;
P is the percentage of time for Personal/Tutored learning; and
C is the percentage of time for Collaborative/Conceptual learning.

The number of lessons for a predetermined period (e.g., 1 week) for a mode of learning is provided by Equation 2 below:

$$NL = \frac{MN * Mode}{MPL} \qquad ( Eq . 2 )$$

Where:
NL is the number of lessons for a mode of learning;
MN is the time period (e.g., minimum number of minutes per week);
Mode is the percentage of time for a particular mode; and
MPL is the time for each lesson.

The track (e.g., 1 to 4) and percentages for each mode of learning are adjusted based on the success rate (SR) for the student (or an average for a group of students). In one embodiment, the default track is the average track (i.e., track 2) and the default plan is 1. The success rate is defined herein as a fraction of the successes with respect to the failures, as provided in Equation 3 below.

$$SR = \frac{S}{S + F} \qquad ( Eq . 3 )$$

Where:
SR is the success rate;
S is the number of times the student has succeeded; and
F is the number of times the student has failed.

A success (S) is when a student meets or exceeds a predetermined mastery threshold (M) for a test or tutoring session (e.g., 75% on a test) and failure (F) is when the student is below the threshold M based on an assessment (A). Put differently a success is when A≧M and F is when A<M. The predetermine threshold M may be set by the system to a default value (e.g., 75%) and/or can be adjusted/set by the teacher.

In various embodiments, the adjustments to the PLP for a student based on the assessment may be performed automatically by the computing system or in cooperation with the teacher by providing suggestions to the teacher. For example, one or more notifications may be provided to the teacher either directly on their display or in e-mail/text message. Accordingly, while the example of FIG. 21 is discussed herein in the context of automatic adjustments, it will be understood that in other embodiments, all or some of the adjustments to the PLP can also be performed with teacher cooperation by the system sending notifications to the teacher and allowing the teacher to make the adjustment(s) to the PLP.

In one embodiment, if the SR is between a first predetermined threshold (e.g., 60%) and a second predetermined threshold (e.g., 80%), where the second predetermined threshold is higher than the first, then no adjustment is performed by the system. Put differently, the automatic system has identified that the PLP for this student (or group of students) is working and does not need an adjustment in the track or percentage of learning mode at that time. Such assessment (A) may be performed at predetermined intervals (e.g., every month, grading period, etc.).

If the SR is below the first predetermined threshold (e.g., 60%), then the system performs an adjustment automatically. For example, the student's collaborative/conceptual percentage is lowered by a predetermined amount while the personal/tutoring percentage is increased by a predetermined amount, such that the total percentage between all modes of learning is maintained at 100%. In one embodiment, the system displays an error message when the sum of the percentages does not total 100%. Alternatively, instead of making the adjustments to the PLP automatically, the system may cooperate with a teacher (e.g., “cooperation with the teacher mode”) by sending a notification similar to: “The student is performing below expectations. Please adjust the modes of learning percentages. It is recommended to lower the student's conceptual/collaborative percentage and increase the personal/tutoring percentage.”

Further, if the collaborative/conceptual percentage for the mode of learning is at a minimum (C=0%) while SR<first predetermined threshold, then the student's foundational percentage is decreased by a predetermined amount and the personal tutoring/percentage is increased by the same amount, thereby maintaining the total percentage between all the modes of learning at 100%. When in the “cooperation with the teacher” mode, a notification similar to the following may be sent to the teacher: “The student is performing below expectations. Please adjust the modes of learning percentages, to lower the student's foundational percentage and increase the personal/tutoring percentage.”

If the personal/tutoring mode exceeds a predetermined threshold (e.g., P>50%) while SR<first predetermined threshold, then the track identifier (T) is automatically adjusted to T−1. For example, if a student is on an accelerated track (3), then the student is adjusted to the average track (2). The adjustment is executed because the student is performing below expectations for the particular track and an excessive amount of the student's time is spent in “one-on-one” sessions with the teacher (the goal being that the student is given an appropriate amount of work that they may finish on their own without using up teacher/tutoring resources). When in the “cooperation with the teacher” mode, a notification similar to the following may be sent to the teacher: “The student is performing below expectations. Please adjust the student's track by lowering it by one track.”

If the SR is above the second predetermined threshold (e.g., 80%), then the system automatically lowers the student's foundational percentage by a predetermined amount and increases the collaborative/conceptual percentage by a predetermined amount, such that the total percentage between all modes of learning is maintained at 100%. When in the “cooperation with the teacher” mode, a notification similar to the following may be sent to the teacher: “The student is performing above expectations. Please adjust the modes of learning percentages. It is recommended to lower the student's foundational percentage and increase the collaborative/conceptual percentage.”

Further, if the collaborative/conceptual percentage for the mode of learning is above a predetermined threshold (e.g., C>50%) while the SR>the second predetermined threshold (e.g., 80%), then the student's personal/tutoring percentage is lowered by a predetermined amount and the collaborative/conceptual percentage is increased by a predetermined amount such that the total percentage between all the modes of learning is maintained at 100%. When in the “cooperation with the teacher” mode, a notification similar to the following may be sent to the teacher: “The student is performing above expectations. Please adjust the modes of learning percentages. It is recommended to lower the student's personal/tutoring percentage and increase the collaborative/conceptual percentage.”

If the foundational percentage for the mode of learning is at a minimum (F=0%) while SR>second predetermined threshold, then the student's track is increased by one step (e.g., T+1). When in the “cooperation with the teacher” mode, a notification similar to the following may be sent to the teacher: “The student is performing above expectations. Please increase the student's track by a step.”

Hence, aspects of the methods adjusting the learning content provided to a student in the on-line e-learning environment as outlined above may be embodied in programming. Program aspects of the technology may be thought of as “products” or “articles of manufacture” typically in the form of executable code and/or associated data that is carried on or embodied in a type of non-transitory machine readable medium.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein.

The components, steps, features, objects, benefits and advantages that have been discussed herein are merely illustrative. None of them, nor the discussions relating to them, are intended to limit the scope of protection. Unless otherwise stated, all measurements, values, ratings, positions, magnitudes, sizes, and other specifications that are set forth in this specification are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

What is claimed is:

1. A system for adjusting learning content provided to a student in an on-line e-learning environment comprising:
a server having access to a database containing custom learning objects categorized into modes of learning that are stored in non-volatile memory;
a network device having a display, the network device being in communication with the server and in conjunction with the server having computer executable instructions stored in a memory device that enable steps including:
displaying a series of custom learning objects through a course delivery system that form at least part of an e-learning course, the series of custom learning objects having a mix of the modes of learning;
assessing a proficiency of the student relating to content of the series of custom learning objects;
determining a revised mix for the modes of learning based on the assessment of the proficiency of the student and the modes of learning for the custom learning objects; and
displaying an additional series of custom learning objects to the student through the course delivery system, where the additional custom learning objects are based on the revised mix for the modes of learning.

2. The system of claim 1, wherein the modes of learning comprise any of foundational, personal, tutoring, collaborative, and conceptual.

3. The system of claim 1, wherein the assessing of the proficiency of the student is based on a success rate (SR) defined as:
$$SR = \frac{S}{S + F}$$
where S represents a number of assessments of success, and F represents a number of assessments of failure.

4. The system of claim 3, wherein:
a success is defined as the student scoring at or above a predetermined mastery threshold for a test or tutoring session; and
a failure is defined as the student scoring below the predetermined mastery threshold for the test or tutoring session.

5. The system of claim 2, wherein the custom learning objects are based on a plurality of learning tracks.

6. The system of claim 5, wherein each of the plurality of learning tracks has a different time per lesson.

7. The system of claim 5, wherein there is an inverse relationship between the time per lesson and a number of lessons allocated for each mode of learning.

8. The system of claim 7, wherein the number of lessons (NL) for a predetermined period for a specific mode of learning is defined as:
$$NL = \frac{MN * Mode}{MPL}$$
where MN is a minimum total allocated learning time, Mode is a percentage of time allocated to the specific mode of learning, and MPL is a length of time for each lesson.

9. The system of claim 5, wherein the network device in conjunction with the server has further executable instructions stored in the memory that enable adjusting the learning track for the additional series of custom learning objects based on the assessment of the proficiency and the mix of the modes of learning.

10. The system of claim 6, where the network device in conjunction with the server has further executable instructions stored in the memory that enable, upon determining that the success rate is between a first predetermined threshold and a second predetermined threshold, wherein the second predetermined threshold is larger than the first predetermined threshold, maintaining the track and the percentage of each learning mode with respect to a total allocated learning time for a predetermined period.

11. The system of claim 10, where the network device in conjunction with the server has further executable instructions stored in the memory that enable, upon determining that the success rate is below the first predetermined threshold:
lowering a combination of the student's collaborative and conceptual modes of learning percentages by a first amount; and
increasing a combination of the personal and tutoring modes of learning percentages by a second amount,
wherein a total percentage of a combination of percentages of all modes of learning is maintained at 100%.

12. The system of claim 10, where the network device in conjunction with the server has further executable instructions stored in the memory that enable, upon determining that the success rate is below the first predetermined threshold and a combination of the collaborative and conceptual modes of learning is at 0%:
lowering the student's foundational mode of learning percentage by a first amount; and
increasing a combination of the personal and tutoring modes of learning percentages by the second amount,
wherein a total percentage of a combination of percentages of all modes of learning is maintained at 100%.

13. The system of claim 10, where the network device in conjunction with the server has further executable instructions stored in the memory that enable, upon determining that the success rate is below the first predetermined threshold and a combination of the personal and tutoring modes of learning exceeds a third predetermined threshold, lowering the learning track by a single track level.

14. The system of claim 10, where the network device in conjunction with the server has further executable instructions stored in the memory that enable, upon determining that the success rate is above the second predetermined threshold:
lowering the student's foundational mode of learning percentage by a first amount; and
increasing a combination of the collaborative and conceptual modes of learning percentages by a second amount,
wherein a total percentage of a combination of percentages of all modes of learning is maintained at 100%.

15. The system of claim 10, where the network device in conjunction with the server has further executable instructions stored in the memory that enable, upon determining that the success rate is above the second predetermined threshold and a combination of the collaborative and conceptual percentages for the mode of learning exceeds a third predetermined threshold:
lowering a combination of the student's personal and tutoring modes of learning percentages by a first amount; and
increasing a combination of the collaborative and conceptual modes of learning percentages by a second amount,
wherein a total percentage of a combination of percentages of all modes of learning is maintained at 100%.

16. The system of claim 10, where the network device in conjunction with the server has further executable instructions stored in the memory that enable, upon determining that the success rate is above the second predetermined threshold and the foundational percentage for the mode of learning is at 0%, increasing the learning track by a single track level.

17. A method of electronically adjusting learning content provided to a student in an on-line e-learning environment, the method comprising:
displaying on an electronic display a series of custom learning objects that form at least part of an e-learning course, the series of custom learning objects having a mix of modes of learning;
assessing, by a network device, a proficiency of the student relating to content of the series of custom learning objects;
determining, by the network device, a revised mix for the modes of learning based on the assessment of the proficiency of the student and the modes of learning for the custom learning objects; and
displaying, on the electronic display, an additional series of custom learning objects to the student through the course delivery system, where the additional custom learning objects are based on the revised mix for the modes of learning.

18. The method of claim 17, wherein the modes of learning comprise any of foundational, personal, tutoring, collaborative, and conceptual.

19. The method of claim 17, wherein the assessing of the proficiency of the student is based on a success rate (SR) defined as:
$$SR = \frac{S}{S + F}$$
where S represents a number of assessments of success, and F represents a number assessments of failure.

20. The method of claim 17, wherein:
a success is defined as the student scoring at or above a predetermined mastery threshold for a test or tutoring session; and
a failure is defined as the student scoring below the predetermined mastery threshold for the test or tutoring session.

21. The method of claim 18, wherein the custom learning objects are based on respective tracks having different times per lesson.
